(19) United States
(12) Patent Application Publication
(10) Pub. No.: US 2006/0157894 A1
(43) Pub. Date: Jul. 20, 2006

(54) Method of forming wax into sculptured art forms

(76) Inventors: Larry D. Couch, San Bernardino, CA (US); Gale E. Couch, San Bernardino, CA (US)

Correspondence Address: Larry D. Couch, 2530 W. KERN ST., SAN BERNARDINO, CA, 92407, US

(21) Appl. No.: 11/331,992

(22) Filed: Jan. 14, 2006

Related U.S. Application Data
(60) Provisional application No. 60/644,509, filed on Jan. 18, 2005.

(51) Int. Cl. B29C 67/24

(52) U.S. Cl. 264/330

(57) ABSTRACT

A unique method of causing hot liquid wax to form into unique shapes as it cools. When wax is cooled in water it solidifies, so whatever form it is in when it comes in contact with cooler water is the way it will appear in it's solidified state. By using a simple method of introducing wax to water causes some of the most unusual and beautiful sculptured art forms that you can imagine, they will have shapes of many kinds like concavity's-con vexes-recesses-chambers-twists-depressions-acclivity's-folds-cusp's-convoluted cusp's with many different lengths and widths and all of these randomly appearing throughout the art form and each time another one is made these qualities will appear in areas of the art form in a totally random way and if you were to create a multitude of them, not one would be like any other yet it would be obvious by looking at any one of them that they were all created by the same method even if individual people had made them.

### CROSS-REFERENCE TO RELATED APPLICATIONS

Not applicable

### BACKGROUND

1. Field of Invention

My method relates to a new way of forming wax like substance into art forms and candles.

2. Description of Prior Art

Originally candles were made by melting bee's wax, then dipping a string into the wax then letting it cool and repeating this process until candle was to the desired size. Other products became available for candle making, like paraffin, candles were then poured into round forms, square forms, forms made of a flexible material like U.S. Pat. No. 4,022,862 to Donald W. McBride (1977) which allows the forming of irregular shaped articles. This form will only make one shape, if you want another irregular shaped candle to look different, you then need another flexible type form. There are pillar candles that are round and pillar candles that are square with flowers imbedded next to the outer surface to make it more attractive, similar to U.S. Pat. No. 3,952,992 to Emil Vyprachticky (1976) where outer surface is embedded with objects like sea shells, aquatic fern, flowers, pieces of glass, etc. but the shape of the candle remains the same. Inventors have created several types of candles like U.S. Pat. No. 6,066,329 to David S. Morrison and William J. Hellman (2000) discloses a Transparent stiff gel as the volatile oil in a jar with a wick in the center. U.S. Pat. No. 5,840,246 to Randall Lee Hammons (1998) is a lamp with a lid that supports a wick. There are hundreds of characters and objects that are cast in molds and forms. But nothing that resembles art forms made from the same method where each one is different from all the rest.

### SUMMARY

A method of creating a uniquely shaped art form that has concavity's-convexes-recesses-chambers-twists-depressions-cusp's, all with different lengths and widths and all of these randomly appearing throughout the art form and each time another art form is made with this method these qualities will appear in areas of the art form in a totally random way always looking uniquely different.

### OBJECTS AND ADVANTAGES

Accordingly, several objects and advantages of this art form are;
(a) each art form is uniquely shaped all around and from top to bottom, no two will every be alike.
(b) a new method of creating a new and unique type of candle which is good for the industry.
(c) ability to release more fragrance due to the increased surface area.
(d) no expensive molds to buy.
(e) method of creating this shapely art form is about as quick as making most candles.
(f) a decoration and conversation piece for the home.

Further information of my method will become apparent from a consideration of the ensuing description and photographs

### PHOTOGRAPH FIGURES

Closely related photographs show figures that have the same number but with different suffixes.

FIG. 1 shows a glass container that contains water and two plastic rods.

FIG. 2A shows a pot pouring melted wax into glass container that contains water.

FIG. 2B shows melted wax being poured into container and on top of wax that has just solidified.

FIG. 3A shows plastic rods being used to push solidified wax down into water.

FIG. 3B shows plastic rods continuing to push solidified wax further down into water.

FIG. 3C shows plastic rods pushing the solidified wax down to the bottom of glass container.

FIG. 4A shows art form having just been made in glass container and cooling down.

FIG. 4B shows art form popped up from glass container after wax has cooled.

FIG. 5A shows completed art form.

FIG. 5B shows completed art form turned clockwise 120 degrees.

FIG. 5C shows completed art form turned an additional 120 degrees clockwise.

FIG. 6A shows a hole being drilled in top of art form.

FIG. 6B shows a wick that has been inserted into drilled hole.

FIG. 7 shows pouring of wax to fill glass container.

FIG. 8 shows the base of the art form being sprayed with cold water.

FIG. 9 shows bottom of art form flattened on a hot plate.

FIG. 10A shows art form in glass container at bottom of a chest type freezer filled with water.

FIG. 10B shows art form having released from glass container and floating up towards the surface.

FIG. 11A shows a glass container that has no bottom which is supported by a sheet of styrofoam.

FIG. 11B shows an art form that has been made in bottomless container.

FIG. 12 shows a container with no bottom and holes in its side to allow for the flow of cold water.

### REFERENCE FIGURES AND ALPHABETIC SUFFIXES ON PHOTOGRAPHS

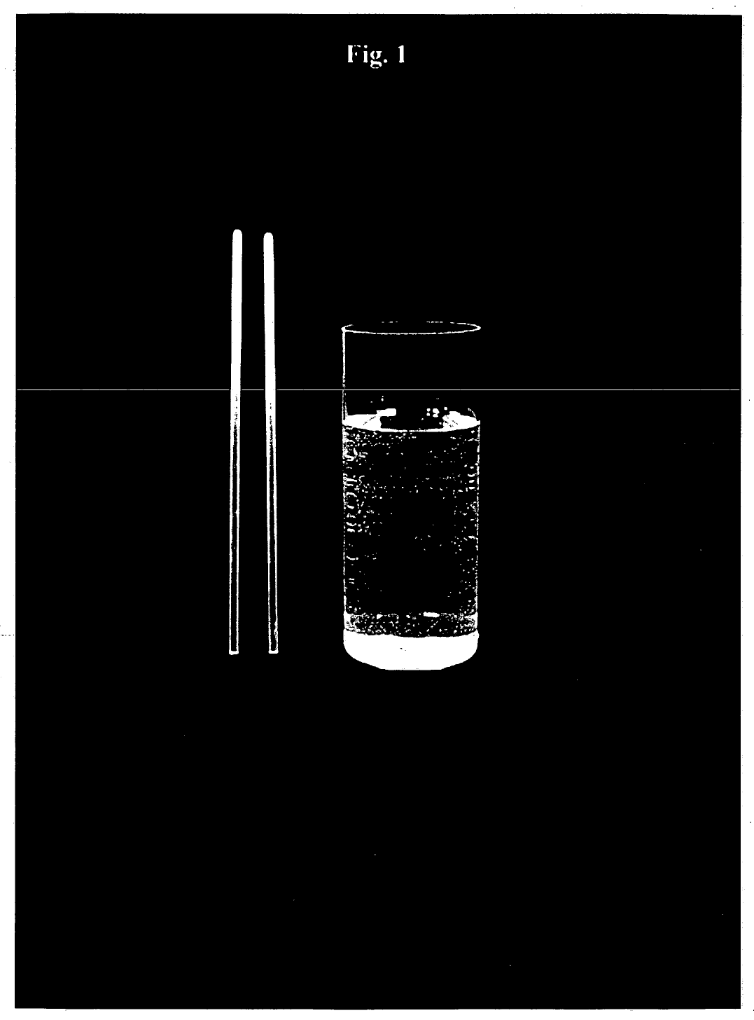

FIG. 1 container filled with water plus rods.

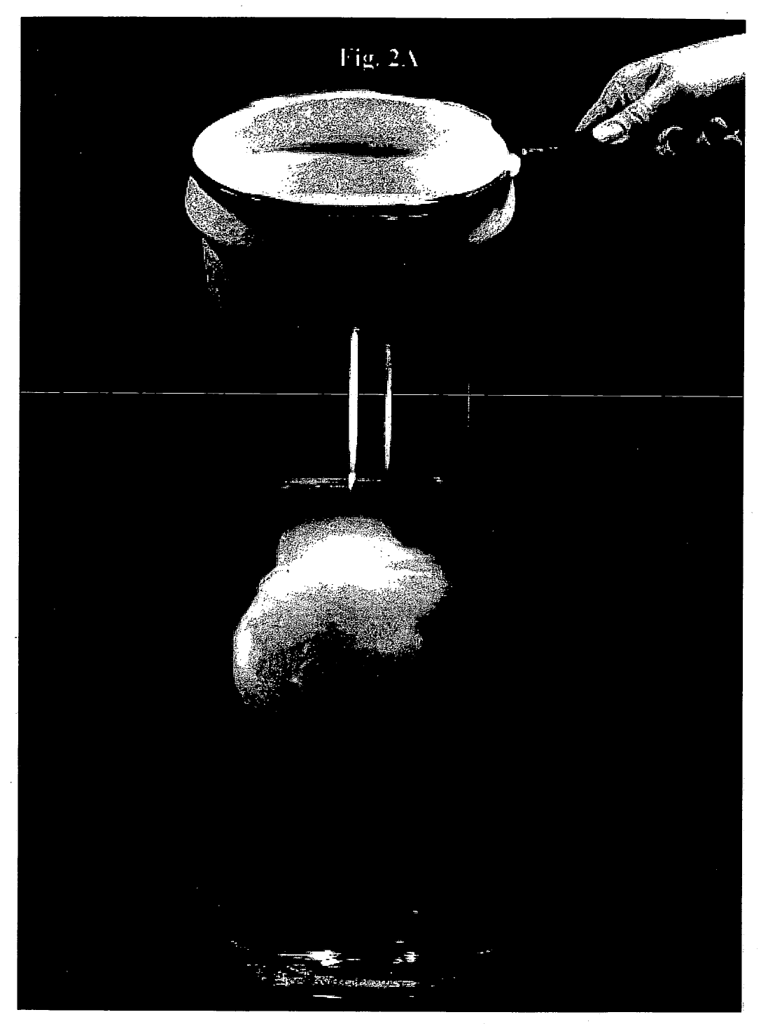

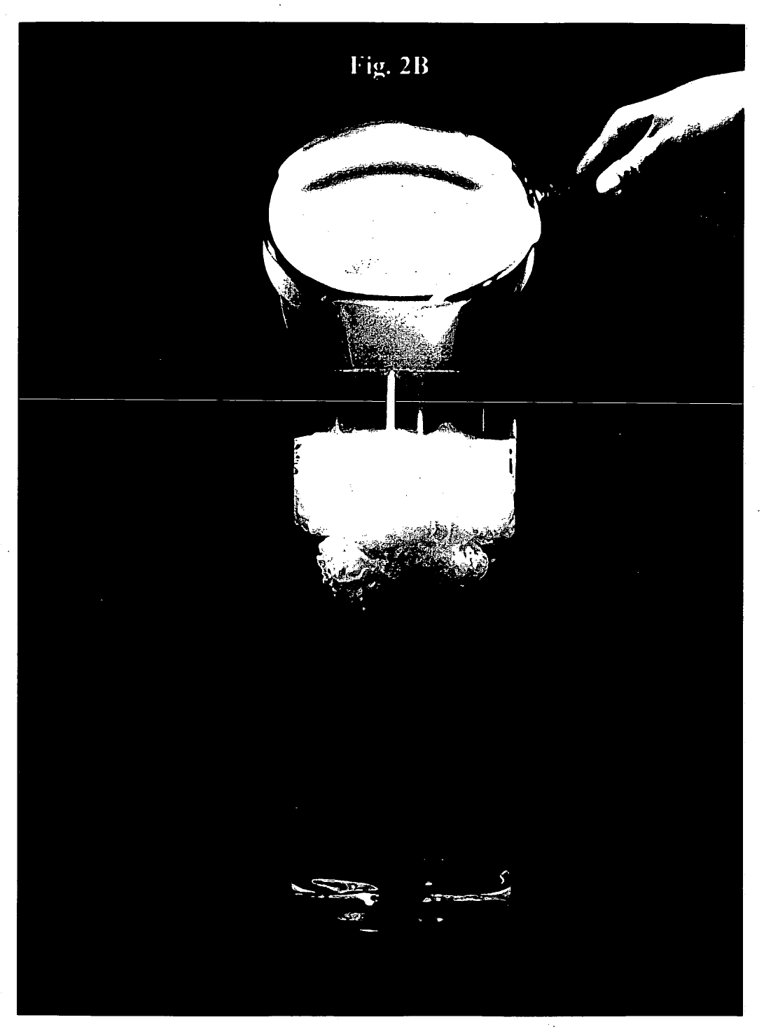

FIG. 2A wax poured in water.

FIG. 2B wax poured on solidified wax.

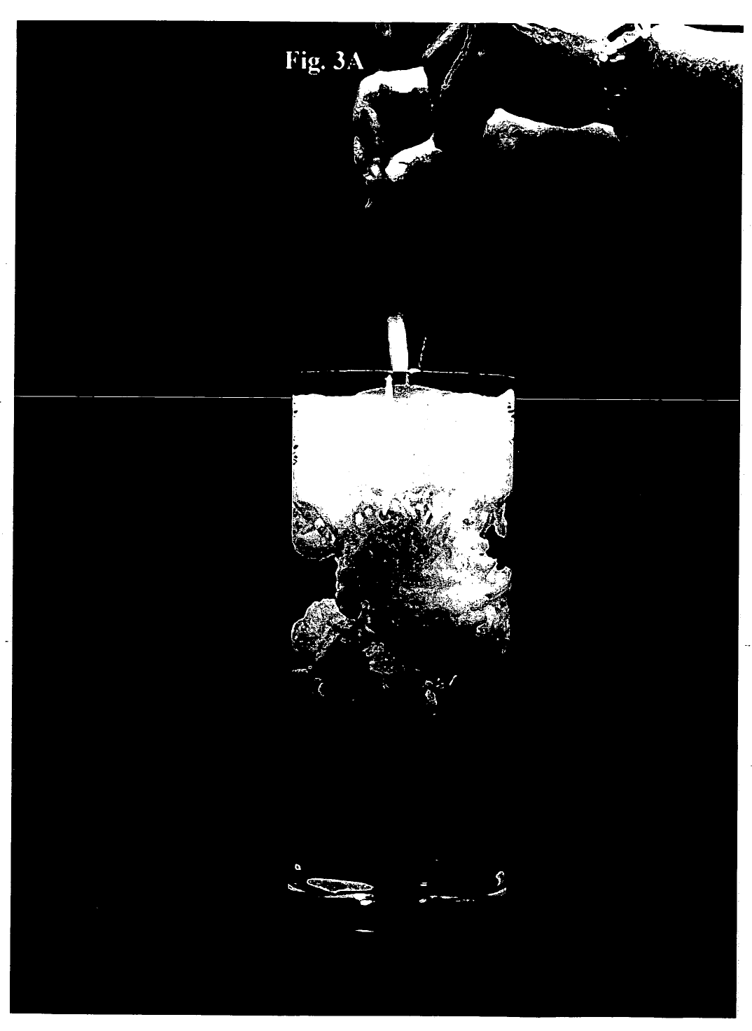

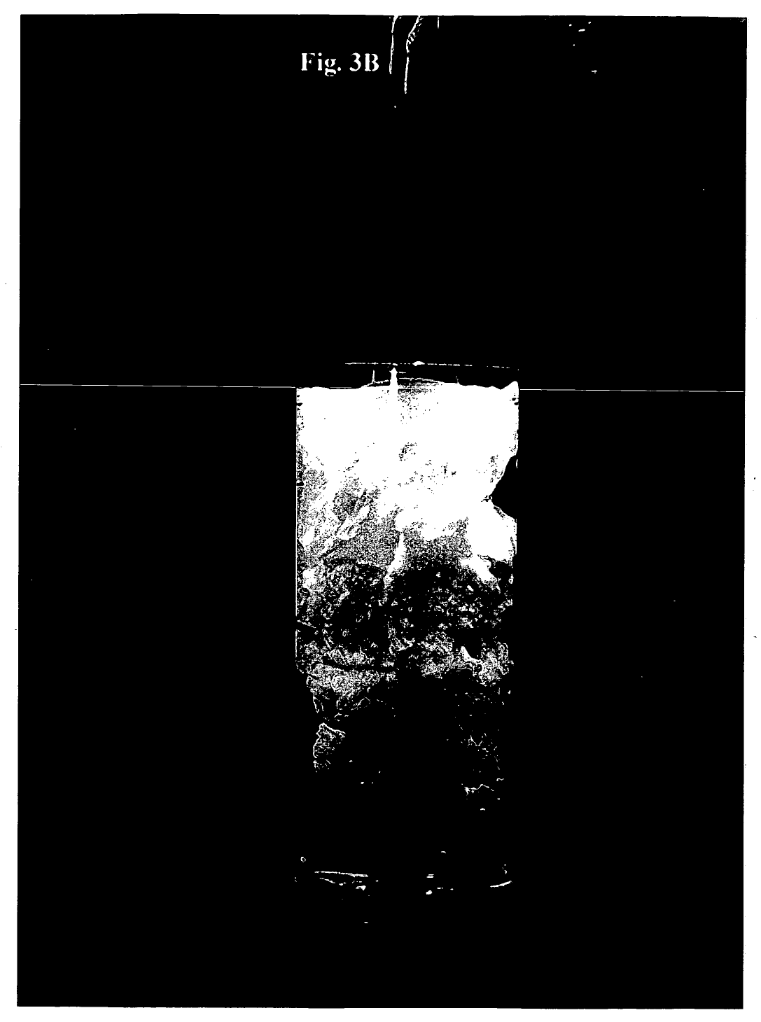

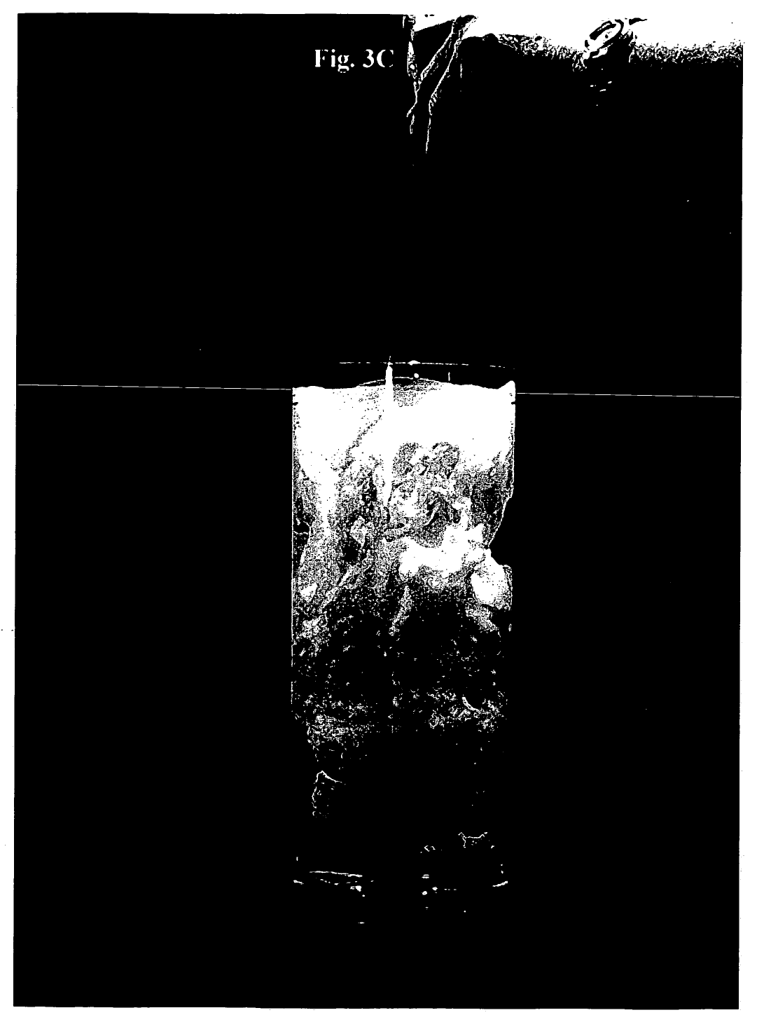

FIG. 3A begin pushing solidified wax.

FIG. 3B continuing to push.

FIG. 3C pushing solidified wax to bottom.

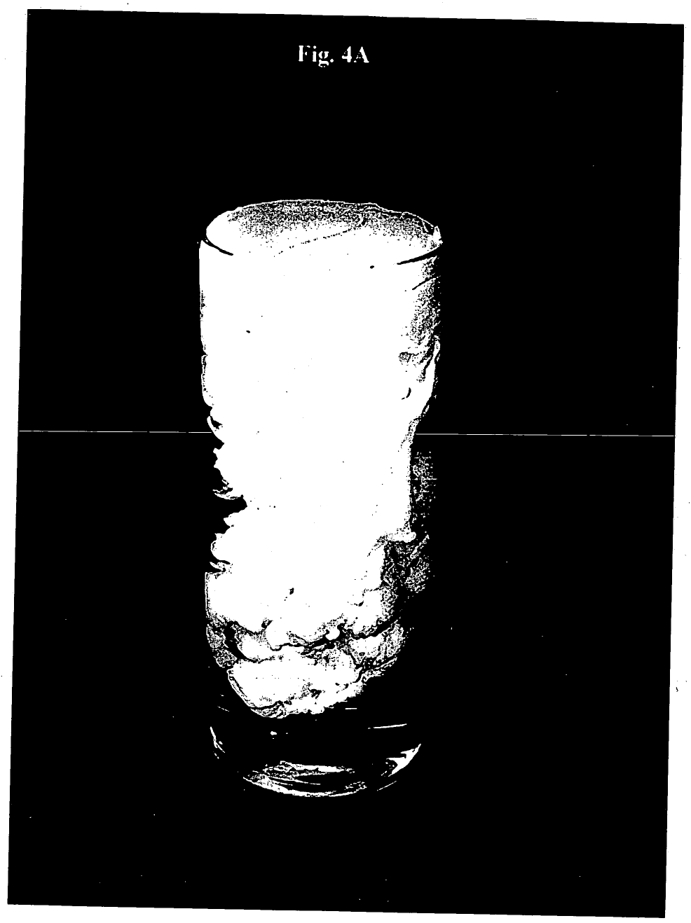

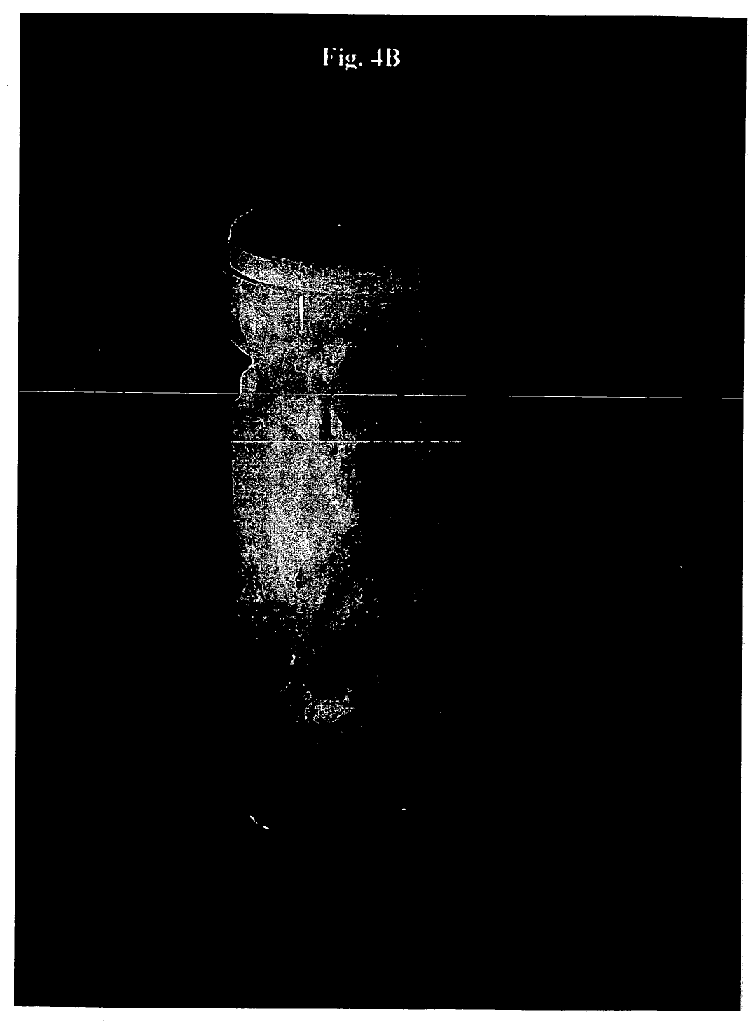

FIG. 4A art form sitting and cooling.

FIG. 4B art form having popped up.

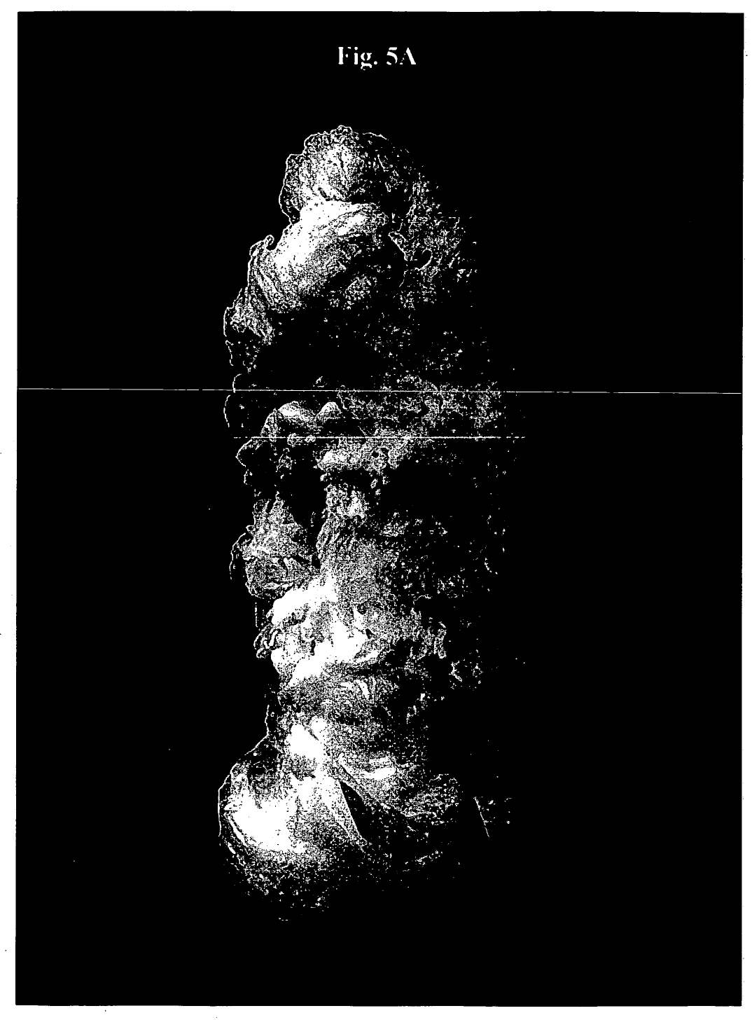

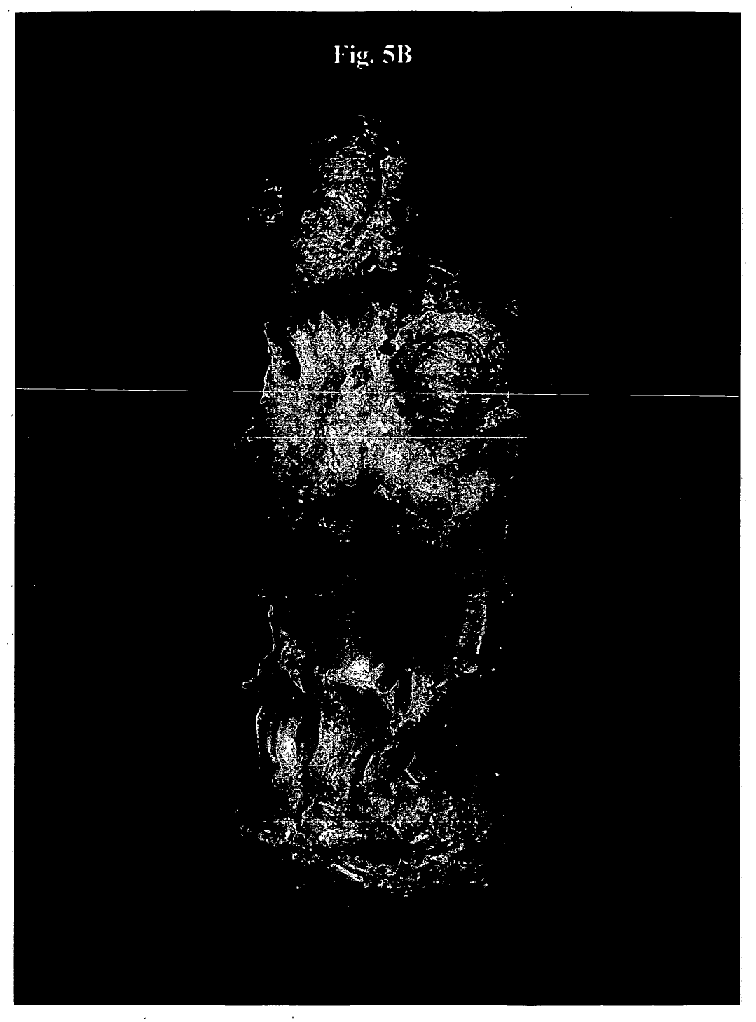

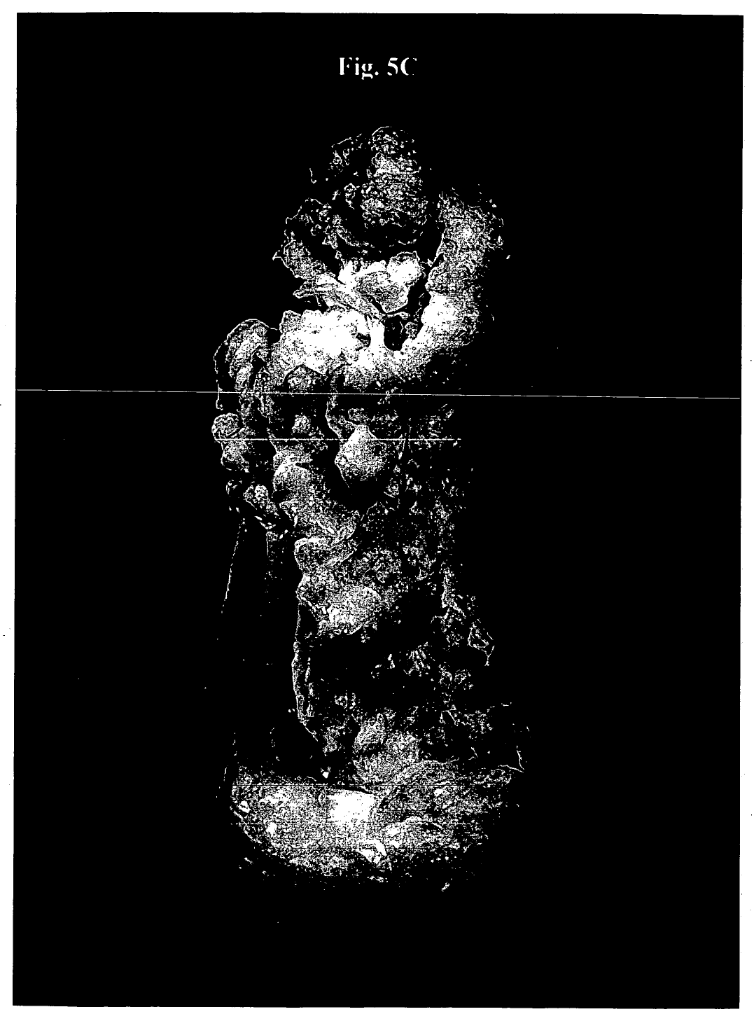

FIG. 5A completed art form.

FIG. 5B completed art form turned 120 degrees.

FIG. 5C completed art form turned additional 120 degrees.

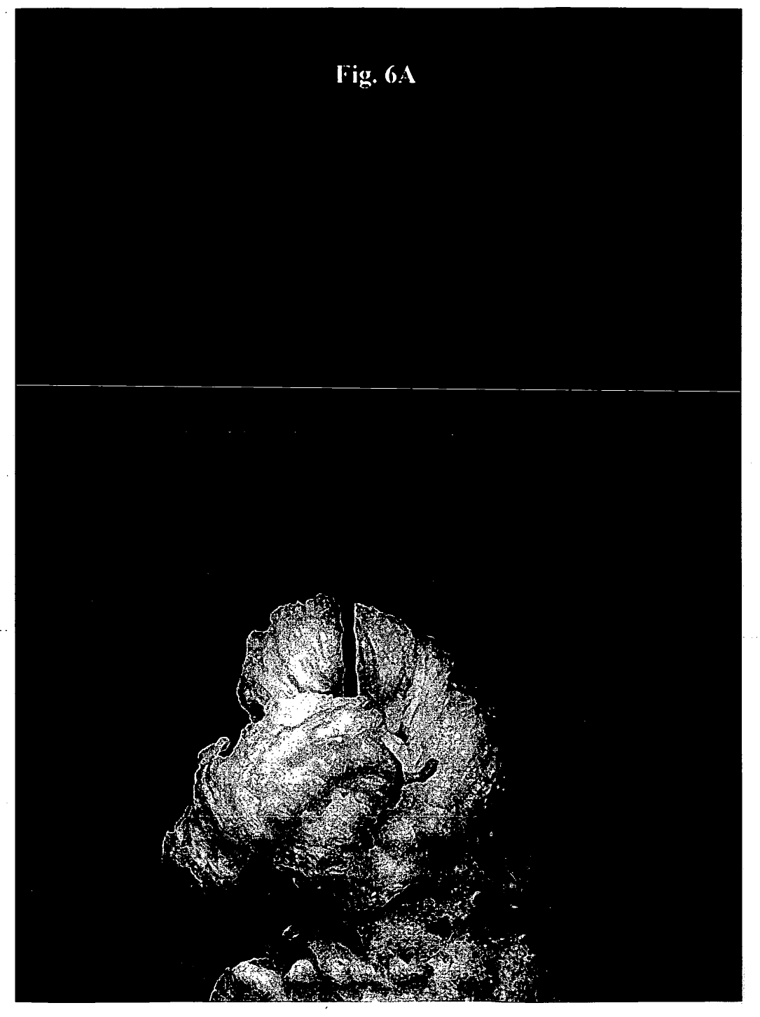

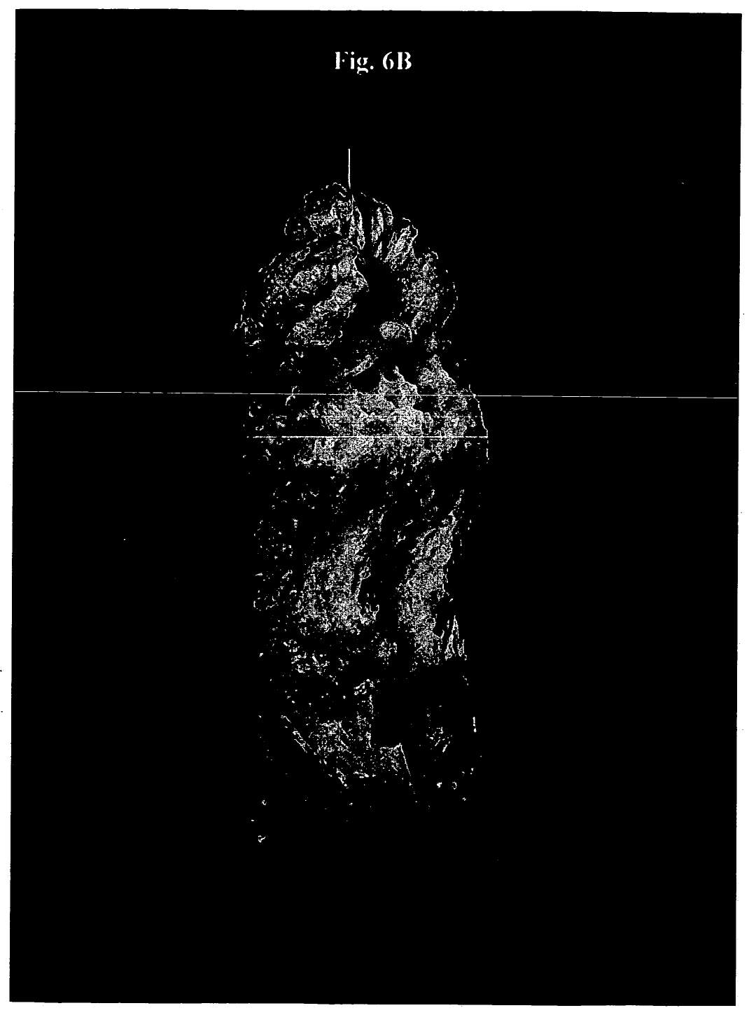

FIG. 6A hole drilled in top of art form.

FIG. 6B art form with wick.

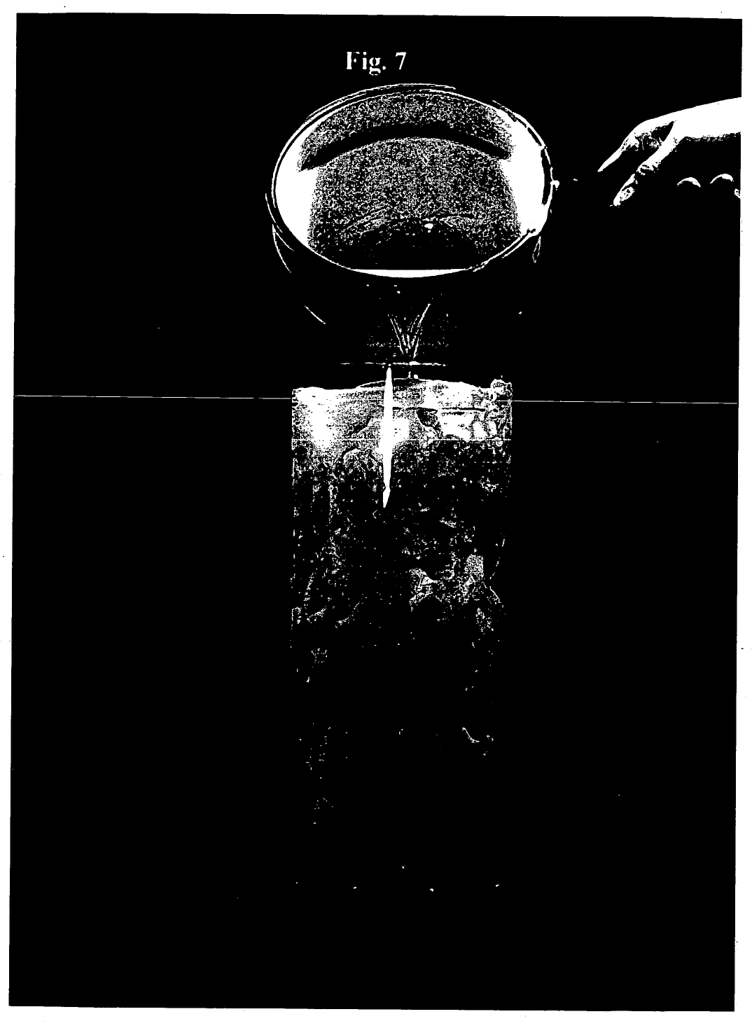

FIG. 7 wax poured to fill container.

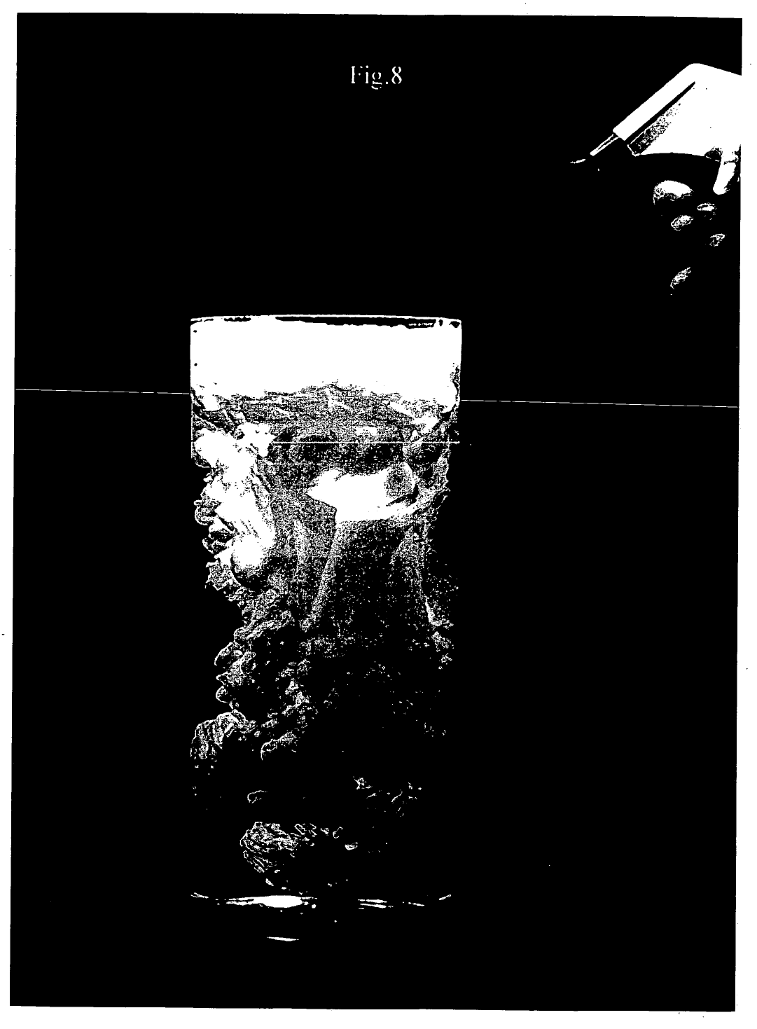

FIG. 8 base being sprayed.

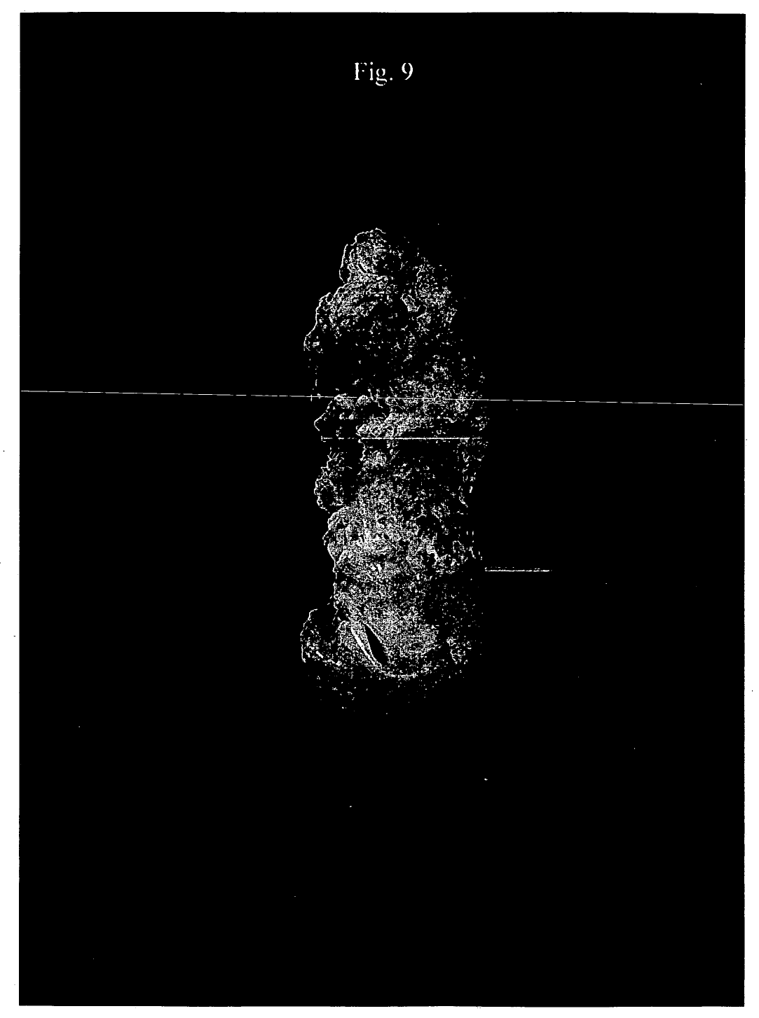

FIG. 9 bottom of art form flattened.

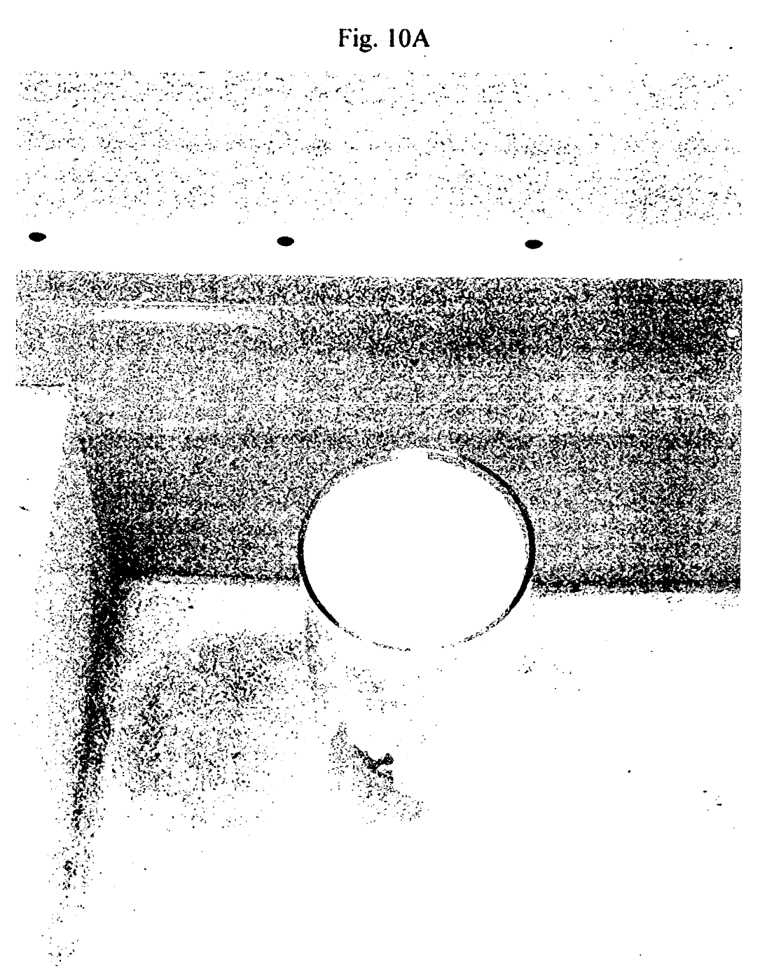

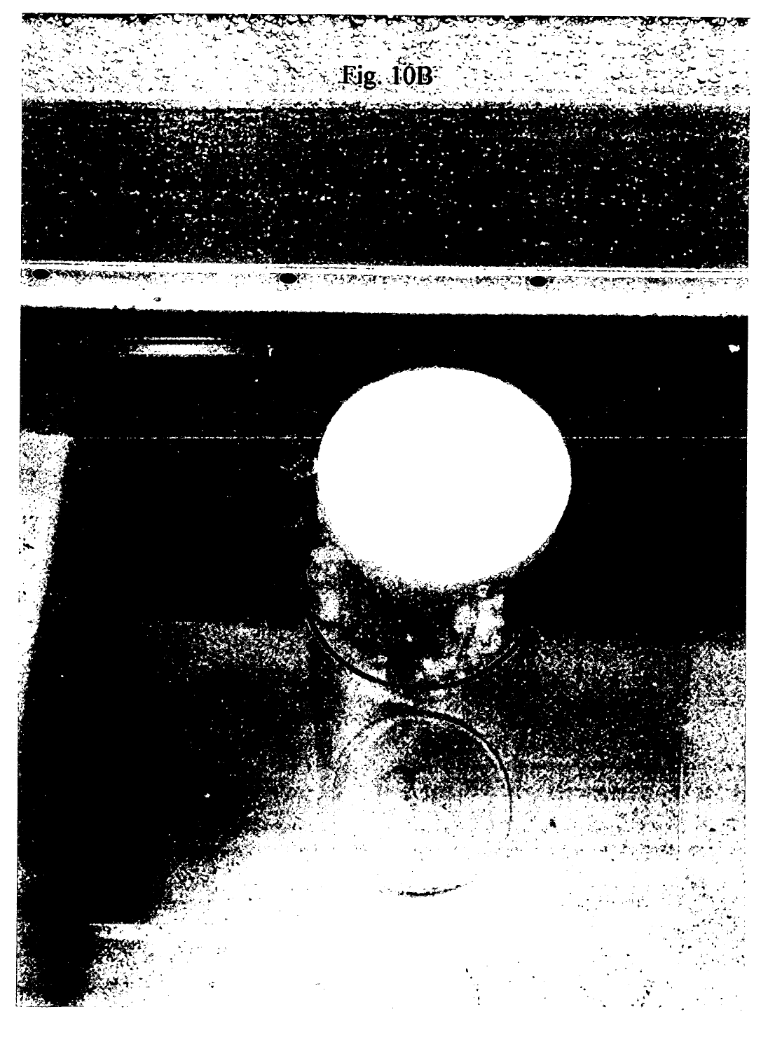

FIG. 10A art form at bottom of chest.

FIG. 10B art form floating up.

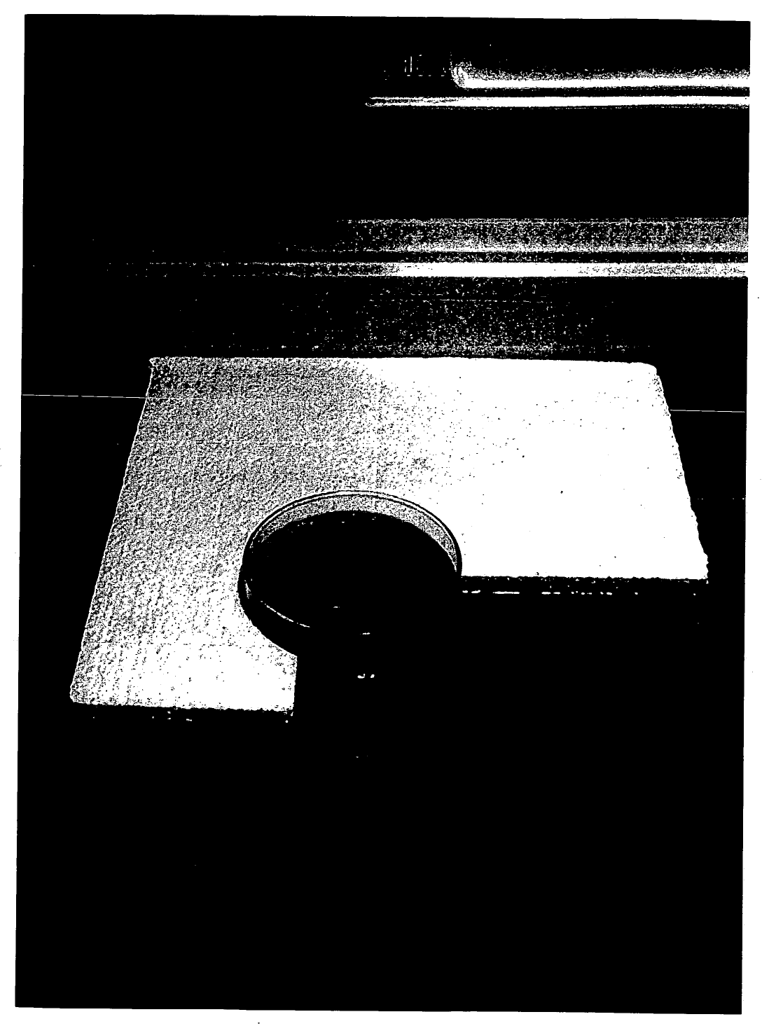

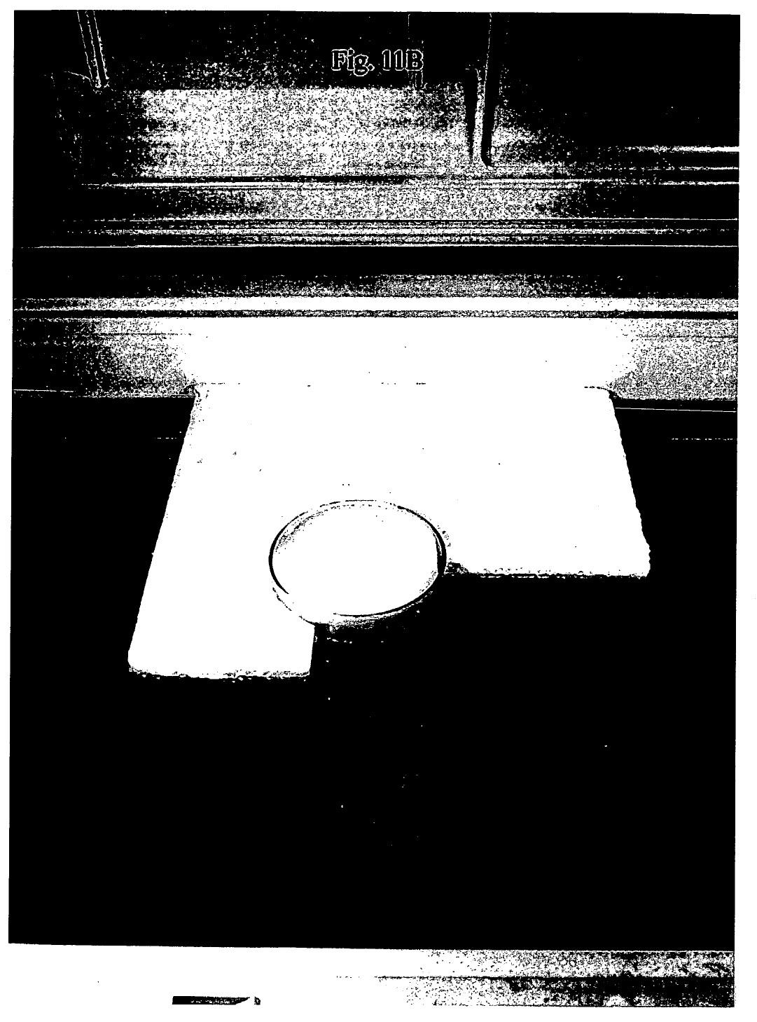

FIG. 11A glass container without a bottom.

FIG. 11B art form in bottomless container.

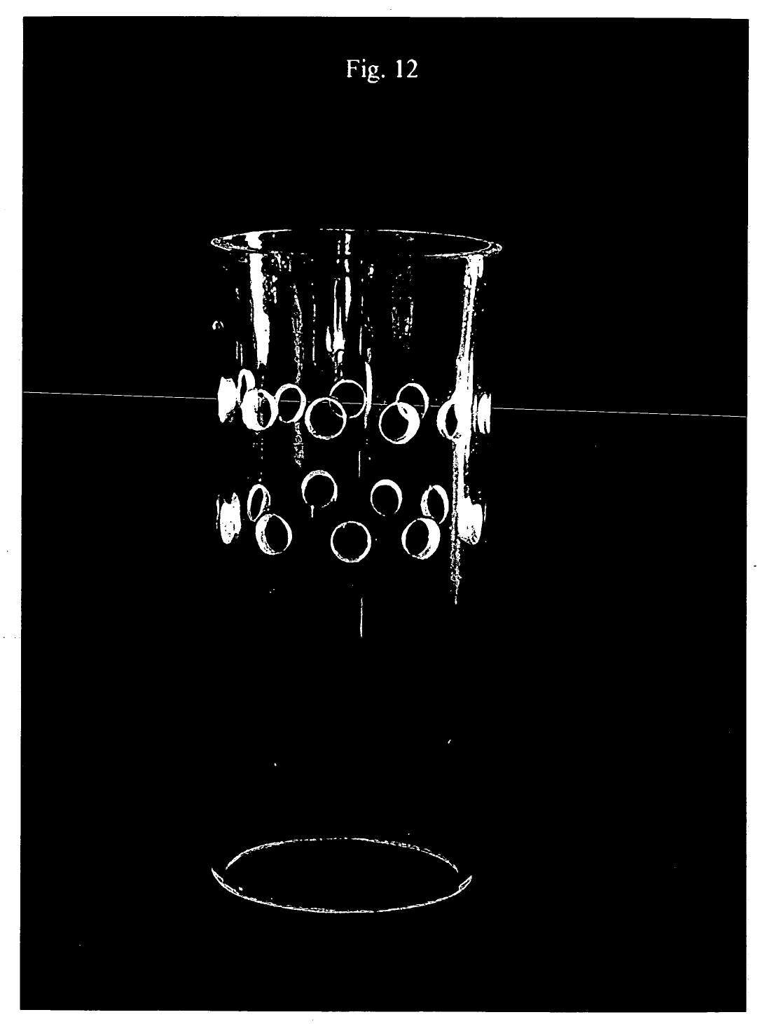

FIG. 12 container with no bottom and holes in it's side.

### DESCRIPTION

FIGS. 1 Through 5C Preferred Embodiment

A preferred embodiment of the method of forming wax into a sculptured candle of the present invention is illustrated in FIG. 1 (a glass container and plastic rods) which are the primary tools used in the method of creating art forms in wax. Cold water is put into the container which has an opening at the top the same size as the lower part of container or bigger so that when art form is created it can be removed without hanging up. The plastic rods can be smooth so wax has very little surface area to cling to as it hardens or rough so wax will cling which gives more control of solidified wax. The rods can be made of wood, glass, metal, plastic, most any material will do, they should be long enough to get a good grip on them in case you want to twist, turn and pull to remove a stuck rod or to create shapes and they should be able to reach to the bottom of the container. The ideal diameter is the size of a large drinking straw, if it is bigger, that gives the wax more surface area to cling to and if it is smaller it has a tendency to poke through the wax that is solidifying, you want to push solidifying wax through the water and not poke through it. One rod is all that is necessary to create an art form but is best to have more so that when wax hardens around one of them which sometimes happens another rod can be used to help free a stuck rod, plus they can be used together. Art forms are easier to create with more than one rod. FIG. 2A shows hot wax being poured from a pot into a container of cold water and the portion in water has already begun to solidify. This wax melting temperature is 143 degrees (61.6 degrees Celsius) and poured at 170 degrees Fahrenheit (76.6 degrees Celsius) that's 27 degrees Fahrenheit (−2.7 degrees Celsius) higher than melting temperature, this will show in the finished art forms sharp features. Wax can be taken to over 100 degrees above it's melting point and more but it is best not to go more than 40 degrees Fahrenheit (4.4 degrees Celsius) above the melting temperature, this is where there is the most control of smoothness or sharpness of the shapes. What temperature you take the wax to and then pour it into water is determined by what type of features on the art form you want, you need to know that when the wax temperature is just a little above it's melting point when it is poured into the water the features are sharper because they solidify immediately. When the wax is 30 degrees Fahrenheit (1.1 degrees Celsius) or more above it's melting point and then poured into the water, the features transition more smoothly into one another. Also the water temperature causes sharper or smoother features depending whether it is just above freezing or at more than 50 degrees Fahrenheit (10 degrees Celsius). if it is close to the freezing point this causes sharper features but if the water is 50 degrees Fahrenheit (10 degrees Celsius) or higher the features become smoother from one area of the art form to another area of the art form, this is due to the amount of time wax takes from the liquid state to a state of solidifying, in other words the longer it takes to solidify the more time it has to transition back to within itself thereby becoming smoother. In FIG. 2B it shows hot liquid wax continuing to be poured on top of wax that has already solidified. The hot liquid wax on top of the solidified wax will remain hot and liquid for many minutes, the hotter the wax the longer it will remain a liquid, it can remain as much as a half hour. The ideal is to be able to create an art form within a few minutes, and the best way is to have a wax that melts between 135 to 145 degrees Fahrenheit (57.2 to 62.7 degrees Celsius) and to heat it to a temperature of 20 degrees Fahrenheit (−6.7 degrees Celsius) above it's melting temperature, and the water should be around 50 degrees Fahrenheit (10 Celsius). Using these temperatures for the wax and water, just about anyone can create an art form the very first time that will look like it was created professionally.

In FIG. 3A both rods are being used, they are put right through the hot liquid wax which is the top part of the wax just poured, the rods are then positioned on top of the solidified wax which is just beneath the hot liquid wax and the rods then push the solidified wax further down into the water which draws hot liquid wax along with the solidified wax and when the hot liquid wax is drawn into the cold water it also solidifies along the path of where the rods have taken it, so with every movement that is performed with the rods, is transmitted into an art form with concavity's-con vexes-recesses-chambers-twists-depressions-convoluted cusp's-cusp's-acclivity's-fold's-drapes—with many different lengths and widths and all of these randomly appearing throughout the art form and each time another art form is made these qualities will appear in areas of the art form in a totally random way creating shapes that will always be unique to the eye.

In FIG. 3B the solidified wax is continuing to be pushed down by the rods showing how the wax takes shape very quick. The solidified wax is pushed down to the bottom of the container in FIG. 3C which is giving the art form it's height. Where ever you stop pushing with the rods and hold them there for about a minute, that will allow the wax to solidify long enough to take set and that will be the height of the art form. Once the art form is to height desired which is shown in FIG. 3C, it should remain in container as shown in FIG. 4A, it should sit and cool off which can take a half hour to over an hour, this cooling off time depends on how cool the water was to begin with and how hot the wax was when it was poured into container, if the water was close to freezing and the wax was just a few degrees above melting temperature, then the time that it will take for the sculptured art form to shrink and pull itself away from the sides of container and pop up above rim of container will usually be under an hour as shown in FIG. 4B but if the water temperature is between 40 and 50 degrees Fahrenheit (4.4 and 10 degrees Celsius) and wax is 40 degrees Fahrenheit (4.4 degrees Celsius) above it's melting point, it will then take over an hour to shrink and pop up.

There are three views of the finished art form which shows the uniqueness of this method, the first view is FIG. 5A, the art form is then turned 120 degrees clockwise as shown in FIG. 5B the view is completely different than the first view, it usually doesn't look like the same art form from one side to the other as is shown when the art form is turned one more time to 120 degrees, although if you look at the top of the art form in each view, you can see how the convoluted cusps are turned in and around one another thereby showing all views belong to the same art form.

FIGS. 6A-6B, 7,9—Additional Embodiment

Additional embodiment is when the art form is made into a candle by drilling a hole down through the top as shown in FIG. 6A and then a wick is put down through drilled hole as shown in FIG. 6B and when a thicker base is preferred, wax is poured into container filling it to the rim as shown in FIG. 7 and when a flat bottom on art for is preferred, it can be flattened on a hot plate as shown in FIG. 9.

FIG. 8, 10A-10B—Alternative Embodiment

When there is a need to create art forms quickly, a tank of water of any size that is practical to work with like the one shown in FIG. 10A which is a 15 cubic foot freezer where the water can be just above freezing to 50 degrees Fahrenheit (10 degrees Celsius) where the container with the newly created art form is now ready to go into tank of water but prior to being submerging, top of container is sprayed with cold water as shown in FIG. 8 to create a surface of solidified wax, then the container is put in tank slowly allowing the water to flow onto the surface of solidified wax slowly so that the water does not wash out the hot liquid wax from beneath the surface of solidified wax, once this is done the container is placed on the bottom of tank as shown in FIG. 10A so that the cool water in tank will help cool the water in the container and thereby cool the wax and when the art form has shrunk which is within 5 to 15 minutes it will release from container and float up to the surface as shown in FIG. 10B.

FIG. 11A-11B, 12—Alternative Embodiment

When wax is used that has a melting point of 160 degrees Fahrenheit (71.1 Celsius) and the temperature is taken up higher than 180 degrees Fahrenheit (82.2 Celsius), the hot liquid wax turns the water in the container warm and becomes more difficult to control the art forms sharp features so the method for keeping the container cool is to use a container that has no bottom (open at both ends) which can be supported by a sheet of Styrofoam that has a round hole cut out to accommodate the container as shown in FIG. 11A and where an art form has been made in bottomless container as shown in FIG. 11B. Other containers work just about as well, as an example, a container with holes in it's side and no bottom as shown in FIG. 12, or a container with a bottom and holes in it's side (not shown) or a container that has holes in it's bottom (not shown) or a container with holes in it's bottom and holes in it' side (not shown) or a container with holes that hoses attach to for the flow of cool water (not shown). A better way to support all containers with holes is with a platform that keeps about ⅓ of the container out of the water until art form has been created and is ready to be lowered into the water and down to the bottom of the tank so that when the art form shrinks it then has room to float to the surface of the chest type freezer (tank).

Alternative Embodiment

When the art forms are turned into a candle they do not always burn as long as an ordinary candle due to the unique shapes and tiny amounts of water that are trapped in art form that at times will extinguish the flame but after awhile that bit of water evaporates and candle can be lit again, this can be remedied when the art form is created by supporting or holding an ordinary candle in the container of water with the top of ordinary candle pointing down and using the ordinary candle as one of the rod's, it is then positioned in the center as hot liquid wax is poured around ordinary candle and into the water and with the other rod, continue to move the solidified wax around creating shapes around the ordinary candle, this way there will be a solid core of wax down through the art form which will then burn like a regular candle.

Alternative Embodiment

After art form has been created it can then be dipped in hot liquid wax to build up the outside, this causes the sharp features to blend more into one another which changes the look of the art form.

Advantages

From the description and the photographs shown, this art form is unique.
(a) It will make a fine craft kit.
(b) These candles give off scent much better than other candles, due to the much larger surface area.
(c) It makes a fine decoration and conversation piece.
(d) It is fun to create because you never know what it looks like until you take it out of container.
(e) Each art form is different from any other, some are more unique than others.
   Operation

Creating these art forms is easy and it's fun, once the principle is understood. This is how the method of creating art forms is done.

Any wax can be used whether it is a high melting point or a low melting point wax. A wax that works well has a melting point of 135 to 145 degrees Fahrenheit (57.2 to 62.7 degrees Celsius) and the water should then be 50 to 60 degrees Fahrenheit (10.0 to 15.5 degrees Celsius).

As the hot liquid wax is poured out of the pot and into the cold water, the first amount to hit the water solidifies and as the hot wax continues to pour out of the pot it collects on top of the solidified wax and remains a hot liquid wax until pulled down into the water by the solidified wax. This pulling down happens when the solidified wax is pushed down further into the cold water by the rod or rods and when this happens the hot liquid wax just above the solidified wax is drawn into the cold water and it also solidifies in whatever direction the rod or rods have caused it to go, this means that with every move of the rod, with every twist, with every pull with every push, the hot liquid wax is turning, twisting, moving up, moving down, following the rods movements. Having a rod become stuck in solidified wax often gives better control of the solidified wax, however, it usually does become more difficult to remove the rod the longer it remains in the solidified wax. Once you push the solidified wax to the bottom of the glass container thereby creating the length of art form desired, remove the rod or rods and let container set until art form shrinks and releases itself from container or if it is to go into chest type freezer (tank) then spray cold water on the hot liquid wax at top of container to cause it to solidify, it is now ready to go into chest type freezer. As you put the container into chest type freezer, allow the water to slowly flow into the top of container, the reason is so the water does not rush in too fast and flush out the hot liquid wax underneath the thin layer of solidified wax. Once the container is in the chest type freezer, wait for the art form to pop up which will happen within 5 to 15 minutes. Once it has popped up allow it to remain in tank for awhile to become cold.

### CONCLUSIONS, RAMIFICATIONS, AND SCOPE OF INVENTION

Thus the reader will see that the method of creating art forms of the invention mentioned provides for an entirely new concept in art. Art forms that can be made by persons of almost any age.

While my above description contains many specificity's, these should not be construed as limitations on the scope of the invention, but rather as an exemplification of one preferred embodiment thereof.

Other variations are possible but I did not consider them important enough to show in a photograph, for example, the base of the art form can be many different shapes like oval, square, rectangle, hexagon, or many other unusual shapes, there can be two or more art forms side by side as in a group and they will come in many different colors and sizes and they can be dipped in liquid wax to build up the outside surface which can be done many times until it is to the size desired.

The same method of creating art forms out of wax can be used to create art forms out of confectionery like chocolate, the confectionery industry will have a new art form to add to their chocolate line by using a low melting temperature chocolate heated to it's liquid state and a higher melting temperature chocolate heated to it's liquid state and by pouring the higher melting temperature chocolate into the lower melting temperature chocolate and then the rod or rod's are used with the same method as was used to create art forms out of wax, thus a new art form will have been formed out of chocolate.

There are several other methods of creating art forms out of wax, one way is to pour hot liquid wax from a pot like vessel and from a distance far enough from the cold water that the wax penetrates the water to the depth which will give height to the art form the wax should be just a few degrees above it's melting point so that when it hits the water that most of it solidifies. The art form is different in it's over all shape and is also unique but not like the preferred embodiment.

Another method is to force liquid wax out of a pressurized nozzle into cold water, again this is unique but does not have the quality of shape that the preferred embodiment has.

Accordingly, the scope of the invention should be determined not by the embodiment illustrated but by the appended claims and their legal equivalents.

I claim:

1. A method of forming a sculptured art form or forms by pouring one fluid into another:
(a) providing a container means of predetermined size with a bottom and
(b) providing a water means that is put into said container which is at a predetermined cool temperature above freezing where surface of said cool water is a predetermined distance from top of said container allowing an area for
(c) a solidified wax means that is preheated to a predetermined temperature causing it to become said heated flowable wax which is poured into said cool water causing the amount of said preheated flowable wax that comes into contact with said cool water to return to said solidified wax but now with a unique shape which is the beginning of the art form and the amount of said preheated wax which remains above said cool water will be moved into said cool water
(d) by providing an elongated device for pushing said uniquely shaped solidified wax further into said cool water which draws said heated flowable wax with it thereby causing it to transition into a sculptured art form of said solidified wax and once said solidified wax has been moved down towards bottom of container by said elongated device, said solidified material is then held there for a predetermined amount of time as said heated flowable material solidifies enough to hold it's sculptured art form and then the said elongated device is removed and said container is, allowed to sit until the sculptured art form shrinks from the sides of said container due to it's solidification and thereby releases itself from said container at which time sculptured art form is removed from said container.
To create art forms quicker a
(1) tank of a predetermined size is provided with said cool water in it as provided in (b) that said containers can be placed into allowing a greater volume of said cool water to influence said heated flowable wax and there is
(2) provided a container that has no bottom and a means of being supported in said tank with said cool water in it as provided in (b) thereby allowing a greater volume of said cool water to influence said heated flowable wax and there is
(3) provided a container that has no bottom and a hole or holes in it's side and a means of being supported in said tank with said cool water in it as provided in (b) thereby allowing a greater volume of said cool water to influence said heated flowable wax and there is
(4) provided a container that has a bottom and a hole or holes in it's side and a means of being supported in said tank with said cool water in it as provided in (b) thereby allowing a greater volume of said cool water to influence said heated flowable wax and there is
(5) provided a container that has a hole or holes in its bottom and a hole or holes in it's side and a means of being supported in said tank with said cool water in it as provided in (b) thereby allowing a greater volume of said cool water to influence said heated flowable wax and there is
(6) provided a container as provided in (a) that has holes with hoses attached to the holes for allowing the flow of said cool water through them by providing a pump device and there is
(7) provided a hole down through the center of art form so a wick can be put down the hole and used as a candle and
(8) providing a material as provided in (b) as a confectionery candy like chocolate at a predetermined temperature which is used while
(9) providing a material as provided in (c) as a confectionery candy like chocolate at a predetermined temperature which has a higher melting temperature than (b) where said chocolate with higher melting temperature is poured into chocolate with lower melting temperature and using the same method as used with said solidified (c) wax thereby turning it into a sculptured art form which will create a new way of presenting confectionery and
(10) providing more than one elongated device as provided in (d) so that when one said elongated device is stuck in said solidified wax the second said elongated device can push against area of solidification while pulling on stuck elongated device thus freeing the stuck elongated device and
(11) providing an elongated device as provided in step (d) as a long Taper Candle of a predetermined size which will be left in art form for burning and
(12) providing said wax in (c) which is wax that is heated up to a predetermined temperature which is in a tub so art form that has been created can be dipped into it which will build up the outside of art form each time the art form is dipped which will cause the sharp features to blend more into one another thereby changing the look of the art form whereby this is a new and unique method of forming sculptured art forms.
